(19) United States
(12) Patent Application Publication
(10) Pub. No.: US 2023/0114366 A1
(43) Pub. Date: Apr. 13, 2023

(54) WORK MACHINE PERIPHERY MONITORING SYSTEM, WORK MACHINE, AND WORK MACHINE PERIPHERY MONITORING METHOD

(71) Applicant: Komatsu Ltd., Tokyo (JP)

(72) Inventors: Taro Eguchi, Tokyo (JP); Koichi Nakazawa, Tokyo (JP); Takeshi Kurihara, Tokyo (JP); Yoshiyuki Shitaya, Tokyo (JP)

(73) Assignee: Komatsu Ltd., Tokyo (JP)

(21) Appl. No.: 17/909,566

(22) PCT Filed: Mar. 9, 2021
(86) PCT No.: PCT/JP2021/009360

§ 371 Date: Sep. 6, 2022

(30) Foreign Application Priority Data
Mar. 19, 2020 (JP) 2020-049548

(51) Int. Cl. E02F 9/24; E02F 9/26

(52) U.S. Cl. CPC E02F 9/24; E02F 9/261

(57) ABSTRACT

A work machine periphery monitoring system includes: a camera 30 as a detection unit that detects a person in a periphery of a work machine; an alarm portion that outputs an alarm; a state determination unit 54 that determines a state of a body of the person detected by the camera 30; and an alarm control unit 56 that controls the output of the alarm by the alarm portion on the basis of a determination result of the state determination unit 54.

### FIELD

The present disclosure relates to a work machine periphery monitoring system, a work machine, and a work machine periphery monitoring method.

### BACKGROUND

In a technical field related to a work machine, a work machine including a periphery monitoring device as disclosed in Patent Literature 1 is known. In Patent Literature 1, a periphery monitoring monitor is arranged in a cab of the work machine. A display unit of the periphery monitoring monitor displays a bird's eye image of a periphery of the work machine.

### CITATION LIST

### Patent Literature

Patent Literature 1: WO 2016/159012

### SUMMARY

### Technical Problem

A periphery monitoring device outputs an alarm in a case where a person is present in a periphery of a work machine. Thus, even in a case where the person in the periphery of the work machine recognizes presence of the work machine, the alarm is output. In a case where the person is present in the periphery of the work machine, it is preferable to output the alarm or suppress the output according to a state of the person.

### Solution to Problem

According to an aspect of the present disclosure, a work machine periphery monitoring system comprises: a detection unit that detects a person in a periphery of a work machine; an alarm portion that outputs an alarm; a state determination unit that determines a state of a body of the person detected by the detection unit; and an alarm control unit that controls the output of the alarm by the alarm portion on a basis of a determination result of the state determination unit.

### Advantageous Effects of Invention

According to the present disclosure, in a case where a person is present in a periphery of a work machine, an output of an alarm can be controlled according to a state of the person.

### BRIEF DESCRIPTION OF DRAWINGS

FIG. 1 is a perspective view illustrating a work machine according to an embodiment.

FIG. 2 is a view illustrating a cab of the work machine according to the embodiment.

FIG. 3 is a view schematically illustrating an upper turning body according to the embodiment.

FIG. 4 is a schematic diagram for describing a detection range and an alarm range according to the embodiment.

FIG. 5 is a functional block diagram illustrating a periphery monitoring device according to the embodiment.

FIG. 6 is a view illustrating an example of a display example of a bird's eye image of a display unit according to the embodiment.

FIG. 7 is a view illustrating another example of the display example of the bird's eye image of the display unit according to the embodiment.

FIG. 8 is a view illustrating another example of the display example of the bird's eye image of the display unit according to the embodiment.

FIG. 9 is a view illustrating another example of the display example of the bird's eye image of the display unit according to the embodiment.

FIG. 10 is a view illustrating another example of the display example of the bird's eye image of the display unit according to the embodiment.

FIG. 11 is a view illustrating another example of the display example of the bird's eye image of the display unit according to the embodiment.

FIG. 12 is a view illustrating an example of a display example of a single camera image of the display unit according to the embodiment.

FIG. 13 is a view illustrating another example of the display example of the single camera image of the display unit according to the embodiment.

FIG. 14 is a flowchart illustrating a periphery monitoring method according to the embodiment.

FIG. 15 is a block diagram illustrating a computer system according to the embodiment.

### DESCRIPTION OF EMBODIMENTS

Although embodiments according to the present disclosure will be described hereinafter with reference to the drawings, the present disclosure is not limited thereto. Components of the embodiments described in the following can be arbitrarily combined. In addition, there is a case where a part of the components is not used.

[Work Machine]

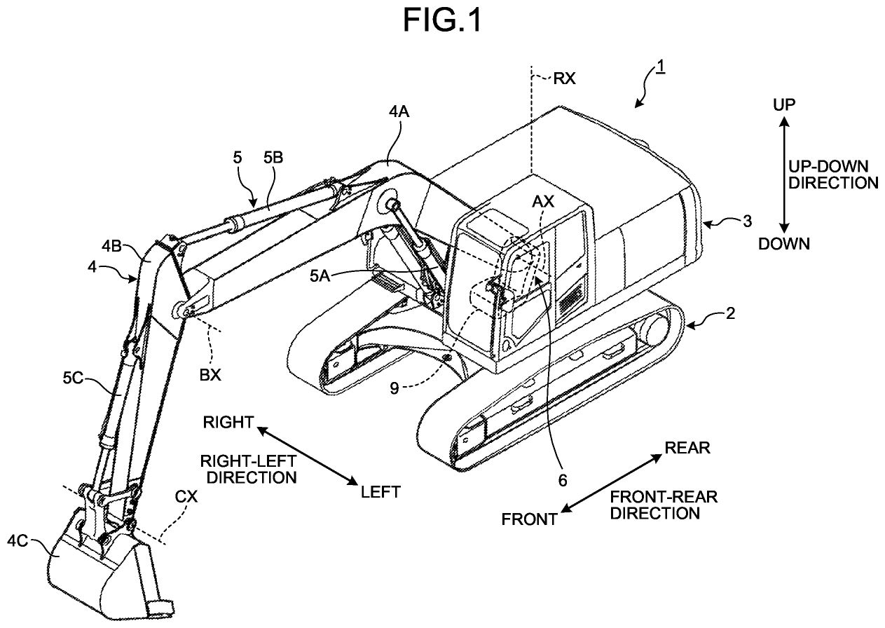

FIG. 1 is a perspective view illustrating a work machine 1 according to an embodiment. In the embodiment, it is assumed that the work machine 1 is an excavator. In the following description, the work machine 1 will be arbitrarily referred to as an excavator 1. The excavator 1 includes a lower traveling body 2, an upper turning body 3 supported by the lower traveling body 2, working equipment 4 supported by the upper turning body 3, and a hydraulic cylinder 5 that drives the working equipment 4.

The lower traveling body 2 can travel in a state of supporting the upper turning body 3. The lower traveling body 2 includes a pair of crawler tracks. The lower traveling body 2 travels by a rotation of the crawler tracks.

The upper turning body 3 can turn about a turning axis RX with respect to the lower traveling body 2 in a state of being supported by the lower traveling body 2.

The upper turning body 3 has a cab 6 on which a driver of the excavator 1 rides. The cab 6 is provided with a driver seat 9 on which a driver sits.

The working equipment 4 includes a boom 4A coupled to the upper turning body 3, an arm 4B coupled to the boom 4A, and a bucket 4C coupled to the arm 4B. The hydraulic cylinder 5 includes a boom cylinder 5A that drives the boom 4A, an arm cylinder 5B that drives the arm 4B, and a bucket cylinder 5C that drives the bucket 4C.

The boom 4A is supported by the upper turning body 3 in a manner of being rotatable about a boom rotation axis AX. The arm 4B is supported by the boom 4A in a manner of being rotatable about an arm rotation axis BX. The bucket 4C is supported by the arm 4B in a manner of being rotatable about a bucket rotation axis CX.

The boom rotation axis AX, the arm rotation axis BX, and the bucket rotation axis CX are parallel to each other. The boom rotation axis AX, the arm rotation axis BX, and the bucket rotation axis CX are orthogonal to an axis parallel to the turning axis RX. In the following description, the direction parallel to the turning axis RX will be appropriately referred to as an up-down direction, a direction parallel to the boom rotation axis AX, the arm rotation axis BX, and the bucket rotation axis CX will be appropriately referred to as a right-left direction, and a direction orthogonal to both the boom rotation axis AX, the arm rotation axis BX, and the bucket rotation axis CX, and the turning axis RX will be appropriately referred to as a front-rear direction. A direction in which the working equipment 4 is present with respect to the driver seated on the driver seat 9 is a front side, and an opposite direction of the front side is a rear side. One of the right and left directions with respect to the driver seated on the driver seat 9 is a right side, and an opposite direction of the right side is a left side. A direction away from a contact area of the lower traveling body 2 is an upper side, and a direction opposite to the upper side is a lower side.

The cab 6 is arranged on the front side of the upper turning body 3. The cab 6 is arranged on the left side of the working equipment 4. The boom 4A of the working equipment 4 is arranged on the right side of the cab 6.

[Cab]

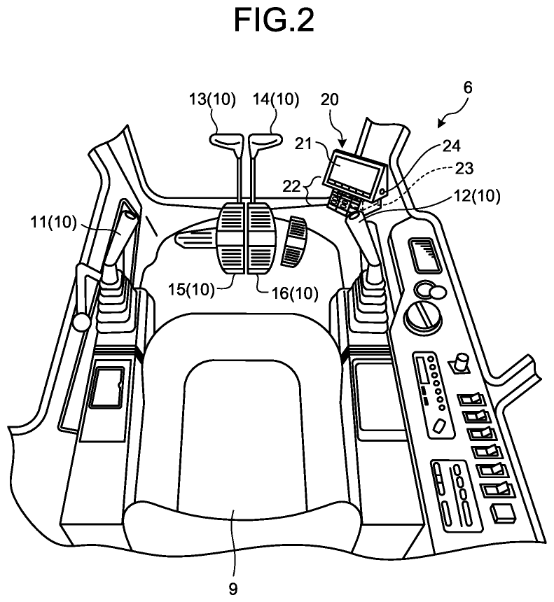

FIG. 2 is a view illustrating the cab 6 of the excavator 1 according to the embodiment. The excavator 1 includes an operation unit 10 arranged in the cab 6. The operation unit 10 is operated for operation of at least a part of the excavator 1. The operation unit 10 is operated by the driver seated on the driver seat 9. The operation of the excavator 1 includes at least one of operation of the lower traveling body 2, operation of the upper turning body 3, or operation of the working equipment 4.

The operation unit 10 includes a left working lever 11 and a right working lever 12 operated for the operation of the upper turning body 3 and the working equipment 4, a left traveling lever 13 and a right traveling lever 14 operated for the operation of the lower traveling body 2, a left foot pedal 15, and a right foot pedal 16.

The left working lever 11 is arrange on the left side of the driver seat 9. When the left working lever 11 is operated in the front-rear direction, the arm 4B performs dumping operation or excavation operation. When the left working lever 11 is operated in the right-left direction, the upper turning body 3 performs a left turn or a right turn. The right working lever 12 is arranged on the right side of the driver seat 9. When the right working lever 12 is operated in the right-left direction, the bucket 4C performs the excavation operation or the dumping operation. When the right working lever 12 is operated in the front-rear direction, the boom 4A performs lowering operation or rising operation.

The left traveling lever 13 and the right traveling lever 14 are arranged on the front side of the driver seat 9. The left traveling lever 13 is arranged on the left side of the right traveling lever 14. When the left traveling lever 13 is operated in the front-rear direction, a left crawler track of the lower traveling body 2 makes forward movement or backward movement. When the right traveling lever 14 is operated in the front-rear direction, a right crawler track of the lower traveling body 2 makes forward movement or backward movement.

The left foot pedal 15 and the right foot pedal 16 are arranged on the front side of the driver seat 9. The left foot pedal 15 is arranged on the left side of the right foot pedal 16. The left foot pedal 15 is interlocked with the left traveling lever 13. The right foot pedal 16 is interlocked with the right traveling lever 14. The lower traveling body 2 may be moved forward or moved backward when the left foot pedal 15 and the right foot pedal 16 are operated.

The excavator 1 includes a periphery monitoring monitor 20 arranged in the cab 6. The periphery monitoring monitor 20 is arranged on a right front side of the driver seat 9. The periphery monitoring monitor 20 includes a display unit 21, an operation unit 22, a control unit 23, and an inner alarm portion 24 that is an alarm portion.

The display unit 21 displays peripheral image data indicating a peripheral situation of the excavator 1. The display unit 21 includes a flat panel display such as a liquid crystal display (LCD) or an organic electroluminescence display (OELD).

The peripheral image data includes one or both of a bird's eye image PDa and a single camera image PDb of the periphery of the excavator 1.

The bird's eye image PDa is an image generated in the following manner. That is, a plurality of pieces of image data, which is respectively acquired by the plurality of cameras 30 that is detection units, is converted into top views and combined. In the bird's eye image PDa, a symbol image 1S indicating the excavator 1 is displayed. The symbol image 1S corresponds to an image of the excavator 1 viewed from above. The symbol image 1S clarifies a positional relationship between the excavator 1 and the periphery of the excavator 1.

The single camera image PDb is an image of a part of the periphery of the excavator 1 which image is acquired by one camera 30 among the plurality of cameras 30. The single camera image PDb includes at least one of a rear single camera image PDb that indicates a rear situation of the excavator 1 and that is acquired by a rear camera 31, a right rear single camera image PDb that indicates a right rear situation of the excavator 1 and that is acquired by a right rear camera 32, a right front single camera image PDb that indicates a right front situation of the excavator 1 and that is acquired by a right front camera 33, or a left rear single camera image PDb that indicates a left rear situation of the excavator 1 and that is acquired by a left rear camera 34.

The operation unit 22 includes a plurality of switches operated by the driver. By operation by the driver, the operation unit 22 outputs an operation command.

The control unit 23 includes a computer system.

The inner alarm portion 24 outputs an alarm toward the inside of the cab 6 of the work machine 1. In the embodiment, the inner alarm portion 24 is a buzzer, and outputs a buzzer toward the inside of the cab 6.

The alarm is output information output when a person is detected. In the embodiment, the description will be made on the assumption that the alarm is a buzzer sound output from the inner alarm portion 24 or an outer alarm portion 60 (described later). However, this is not a limitation. The alarm may be a message or symbol display displayed on the display unit 21, a Patlite (registered trademark) provided in the excavator 1, or a warning light by a display lamp, an LED, or the like provided in the cab 6. In a case of the Patlite, it is possible to alert a person in the periphery of the excavator 1 in addition to the driver in the cab 6.

[Camera]

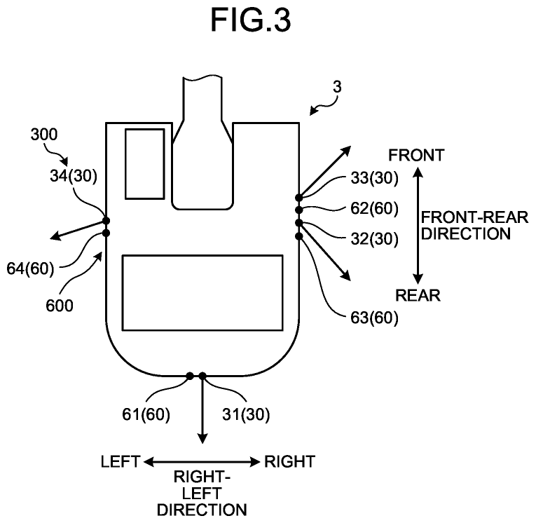

FIG. 3 is a view schematically illustrating the upper turning body 3 according to the embodiment. The excavator 1 includes a camera system 300 including the plurality of cameras 30. The plurality of cameras 30 is provided in the upper turning body 3. The cameras 30 acquire images of an imaging object. The cameras 30 function as detection units that detect a person in the periphery of the work machine 1. The plurality of cameras 30 is arranged around the work machine 1. In the embodiment, the cameras 30 include the rear camera 31 provided at a rear portion of the upper turning body 3, the right rear camera 32 and right front camera 33 that are provided at a right portion of the upper turning body 3, and the left rear camera 34 provided at a left portion of the upper turning body 3.

The rear camera 31 images a rear region of the upper turning body 3. The right rear camera 32 images a right rear region of the upper turning body 3. The right front camera 33 images a right front region of the upper turning body 3. The left rear camera 34 images a left rear region of the upper turning body 3. Each of the plurality of cameras 30 (31, 32, 33, and 34) includes an optical system and an image sensor. The image sensor includes a couple charged device (CCD) image sensor or a complementary metal oxide semiconductor (CMOS) image sensor.

Note that the left rear camera 34 images ranges of a left side region and the left rear region of the upper turning body 3, but may image either one thereof. Similarly, the right rear camera 32 images ranges of a right side region and the right rear region of the upper turning body 3, but may image either one thereof. Similarly, the right front camera 33 images ranges of the right front region and the right side region of the upper turning body 3, but may image either one thereof. In addition, although the cameras 30 image the left rear side, the rear side, the right rear side, and the right front side of the upper turning body 3, this is not a limitation. For example, the number of cameras 30 may be different from the example illustrated in FIG. 3. For example, imaging ranges of the cameras 30 may be different from the example illustrated in FIG. 3.

In the embodiment, there is no camera that photographs the front side and the left front side of the cab 6. This is because the driver seated on the driver seat 9 can visually recognize front and left front situations of the cab 6 directly. As a result, the number of cameras 30 provided in the excavator 1 is controlled. Note that a camera 30 that acquires image data indicating the front and left front situations of the cab 6 may be provided.

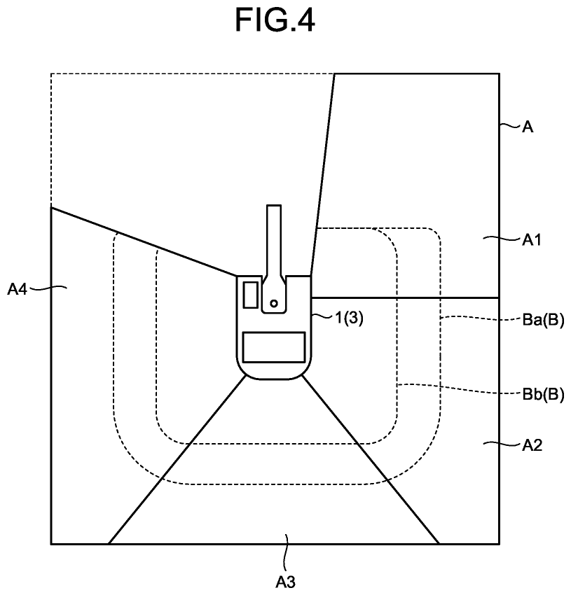

FIG. 4 is a schematic diagram for describing a detection range A and an alarm range B according to the embodiment. Each of the cameras 30 has the detection range

A in which a person can be detected. The detection range A includes a visual field range that is an imageable range of the camera 30. Image processing of image data acquired by the camera 30 is performed by the control unit 23. The image processing of the image data is performed, and it is determined whether a person is present in the detection range A of the camera 30.

[Outer Alarm Unit]

The excavator 1 includes an outer alarm unit 600 including a plurality of outer alarm portions 60 that is alarm portions. The plurality of outer alarm portions 60 is provided in the upper turning body 3. The plurality of outer alarm portions 60 is provided around the cameras 30. The plurality of outer alarm portions 60 outputs alarms in different directions in the periphery of the work machine 1. The plurality of outer alarm portions 60 outputs the alarms toward the outside of the cab 6 of the work machine 1. In the embodiment, the plurality of outer alarm portions 60 is buzzers, and outputs buzzers toward the outside of the cab 6. In the embodiment, the outer alarm portions 60 include an outer alarm portion 61 provided at the rear portion of the upper turning body 3, an outer alarm portion 62 provided at the right portion of the upper turning body 3, and the outer alarm portion 64 provided at the left portion of the upper turning body 3. The outer alarm portion 61 is arranged around the rear camera 31. The outer alarm portion 61 outputs an alarm toward the rear side of the work machine 1. The outer alarm portion 62 is arranged around the right rear camera 32 and the right front camera 33. The outer alarm portion 62 outputs an alarm toward the right rear side, right side, and right front side. The outer alarm portion 64 is arranged around the left rear camera 34. The outer alarm portion 64 outputs an alarm toward the left rear side and left side.

[Periphery Monitoring Device]

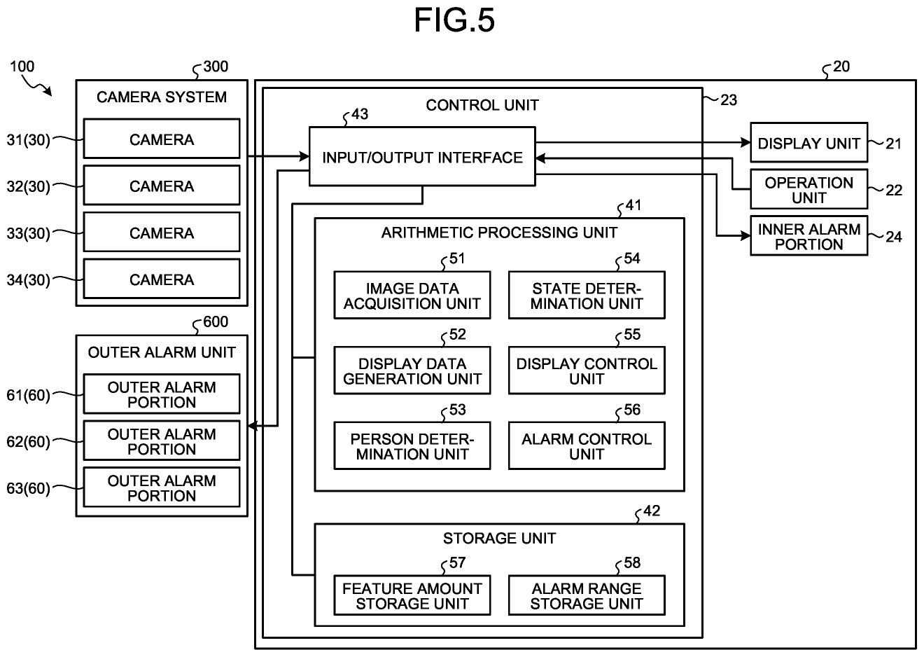

FIG. 5 is a functional block diagram illustrating a periphery monitoring device 100 according to the embodiment. The excavator 1 includes the periphery monitoring device 100. The periphery monitoring device 100 monitors the periphery of the excavator 1. The periphery monitoring device 100 includes a periphery monitoring monitor 20, the camera system 300, and an external alarm unit 600. The periphery monitoring monitor 20 includes the display unit 21, the operation unit 22, the control unit 23, and the inner alarm portion 24. The camera system 300 includes the plurality of cameras 30 (31, 32, 33, and 34). The external alarm unit 600 includes the plurality of outer alarm portions 60 (61, 62, 63, and 64). Note that a periphery monitoring device 100 may have a configuration including no display unit 21 and no operation unit 22. In addition, a periphery monitoring device 100 may have a configuration including only one of an external alarm unit 600 and an inner alarm portion 24.

The control unit 23 includes a computer system. The control unit 23 includes an arithmetic processing unit 41 including a processor such as a central processing unit (CPU), a storage unit 42 including a volatile memory such as a random access memory (RAM) and a non-volatile memory such as a read only memory (ROM), and an input/output interface 43.

The arithmetic processing unit 41 includes an image data acquisition unit 51, a display data generation unit 52, a person determination unit 53, a state determination unit 54, a display control unit 55, and an alarm control unit 56.

The storage unit 42 stores various kinds of data and the like used in processing in the arithmetic processing unit 41. In the embodiment, the storage unit 42 includes a feature amount storage unit 57 that stores a feature amount of a person, and an alarm range storage unit 58 that stores the alarm range B (see FIG. 4).

The feature amount is information that includes an outline of a person, a color of the person, and the like and that specifies an appearance of the person.

The alarm range B will be described with reference to FIG. 4. The alarm range B is a range in which an output of an alarm is required when a person is present. The alarm range B is set in such a manner as to surround the excavator 1. In a case where a person is present inside the alarm range B, an alarm is output. In a case where a person is present outside the alarm range B, the alarm is not output. The alarm range B is smaller than the detection range A. The alarm range B may be the same as the range of the detection range A or wider than the detection range A.

In the embodiment, the alarm range B includes a first alarm range Ba and a second alarm range Bb. The second alarm range Bb is set in such a manner as to surround the excavator 1. The excavator 1 is arranged inside the second alarm range Bb. The second alarm range Bb is defined inside the first alarm range Ba. The second alarm range Bb is smaller than the first alarm range Ba. There may be one or a plurality of alarm ranges B.

In the embodiment, each of the first alarm range

Ba and the second alarm range Bb has a rectangular shape. A front end portion of the first alarm range Ba coincides with a front end portion of the second alarm range Bb. A rear end portion of the first alarm range Ba is defined behind the rear end portion of the second alarm range Bb.

A left end portion of the first alarm range Ba is defined on the left side of a left end portion of the second alarm range Bb. A right end portion of the first alarm range Ba is defined on the right side of a right end portion of the second alarm range Bb.

In a case where a person is present inside the alarm range B, an alarm is output. In a case where no person is present inside the alarm range B, an output of the alarm is stopped. In a case where a person is present inside the second alarm range Bb, operation of a vehicle body of the work machine 1 may be further limited. For example, before the work machine 1 performs traveling operation or turning operation, a start lock that is a prohibition control of the traveling or turning operation may be performed. In addition, when the work machine 1 is traveling, traveling of the lower traveling body 2 may be stopped or decelerated. In addition, during the turning, turning operation of the upper turning body 3 may be stopped or decelerated. In addition, operation of another vehicle body such as the working equipment 1 may be controlled.

The input/output interface 43 is connected to each of the camera system 300, the external alarm unit 600, the display unit 21, the operation unit 22, and the inner alarm portion 24.

The image data acquisition unit 51 acquires image data from the camera system 300. The image data acquisition unit 51 acquires image data indicating the rear situation of the excavator 1 from the rear camera 31. The image data acquisition unit 51 acquires image data indicating the right rear situation of the excavator 1 from the right rear camera 32. The image data acquisition unit 51 acquires image data indicating the right front situation of the excavator 1 from the right front camera 33. The image data acquisition unit 51 acquires image data indicating the left rear situation of the excavator 1 from the left rear camera 34.

On the basis of the image data acquired by the image data acquisition unit 51, the display data generation unit 52 generates peripheral display data indicating a situation in the periphery of the excavator 1. The peripheral display data includes the bird's eye image PDa of the periphery of the excavator 1, and a single camera image PDb of the periphery of the excavator 1. More specifically, the display data generation unit 52 generates the bird's eye image PDa of the periphery of the excavator 1 on the basis of the pieces of image data respectively acquired by the plurality of cameras 30. The display data generation unit 52 generates the single camera image PDb on the basis of the image data acquired by one camera 30 among the plurality of cameras 30.

The display data generation unit 52 converts the image data acquired by each of the rear camera 31, the right rear camera 32, the right front camera 33, and the left rear camera 34 into converted image data indicating a top-view image viewed from a virtual viewpoint above the excavator 1. The display data generation unit 52 cuts out, from the converted image data, a portion corresponding to a frame region in which the bird's eye image PDa is displayed. The display data generation unit 52 combines the cut-out converted image data. As a result, the bird's eye image PDa of the periphery of the excavator 1 is generated. In addition, the display data generation unit 52 combines the symbol image 1S indicating the excavator 1 with the bird's eye image PDa. The symbol image 1S corresponds to an image of the excavator 1 viewed from above. The symbol image 1S clarifies a relative positional relationship between the excavator 1 and the periphery of the excavator 1.

In the embodiment, bird's eye images of the front side and the left front side of the cab 6 are not generated. A camera 30 that acquires image data indicating the front and left front situations of the cab 6 may be provided, and bird's eye images of the front side and left front side of the cab 6.

The person determination unit 53 determines whether a person is present in the periphery of the excavator 1 on the basis of the image data acquired by the image data acquisition unit 51. The person determination unit 53 determines presence or absence of a person in the alarm range B by performing image processing on the image data acquired by the image data acquisition unit 51. The image processing includes processing of extracting a feature amount of a person from the image data. The person determination unit 53 collates the feature amount extracted from the image data with the feature amount stored in the feature amount storage unit 57, and determines whether a person is present in the periphery of the excavator 1, in other words, inside the alarm range B. Furthermore, the person determination unit 53 may recognize a direction of the detected person with respect to the working equipment 1.

Furthermore, the person determination unit 53 determines in which range a person is present among the outside of the first alarm range Ba, the inside of the first alarm range Ba and the outside of the second alarm range Bb, and the inside of the second alarm range Bb. The person determination unit 53 collates a position where the feature amount is extracted in the image data with the alarm range B stored in the alarm range storage unit 58, and determines in which of the ranges the position where the feature amount is extracted is located among the outside of the first alarm range Ba, the inside of the first alarm range Ba and the outside of the second alarm range Bb, and the inside of the second alarm range Bb.

Furthermore, the person determination unit 53 determines in which detection range of a detection range A1, a detection range A2, a detection range A3, or a detection range A4 illustrated in FIG. 4 a person is present. The detection range A1 is a right front range of the detection range A. The detection range A1 overlaps with an imaging range of the right front camera 33. The person determination unit 53 determines that the person recognized from the captured image data of the right front camera 33 is present in the detection range A1. The detection range A2 is a right rear range of the detection range A. The detection range A2 overlaps with an imaging range of the right rear camera 32. The person determination unit 53 determines that the person recognized from the captured image data of the right rear camera 32 is present in the detection range A2. The detection range A3 is a rear range of the detection range A. The detection range A3 overlaps with an imaging range of the rear camera 31. The person determination unit 53 determines that the person recognized from the captured image data of the rear camera 31 is present in the detection range A3. The detection range A4 is a left side and left rear side of the detection range A. The detection range A4 overlaps with an imaging range of the left rear camera 34. The person determination unit 53 determines that the person recognized from the captured image data of the left rear camera 34 is present in the detection range A4.

In a case where the person determination unit 53 determines that a person is present inside the alarm range B, the state determination unit 54 determines whether a state of the person is a state of outputting an alarm on the basis of the image data acquired by the image data acquisition unit 51.

The state of the person indicates a state of a body of the person. The state of the body indicates a direction of the person. Note that the direction of the person may be a direction of a front portion of the body of the person or a direction of a part of the body of the person. The direction of the part of the body of the person is, for example, a direction of both eyes or one eye of the person, a direction of a face portion of the person, a direction of a body or lower limbs of the person, a direction of glasses or a mask worn by the person, a direction of a front body of clothing or toe portions of shoes of the person, or the like.

In addition, in a case where the person determination unit 53 determines that the person is present inside the alarm range B, the state determination unit 54 determines whether a state of the person is a state of suppressing an alarm on the basis of the image data acquired by the image data acquisition unit 51. The state of suppressing the alarm is a state in which the person faces the work machine 1, in other words, a state in which the person recognizes the work machine 1.

For example, in a case where image processing is performed on the image data acquired by the image data acquisition unit 51 and it is recognized that the both eyes or one eye of the person faces the work machine 1, the state determination unit 54 determines that the person is in a state of recognizing the work machine 1. For example, in a case where image processing is performed on the image data and it is recognized that the face portion of the person faces the work machine 1, the state determination unit 54 determines that the person is in the state of recognizing the work machine 1. For example, in a case where image processing is performed on the image data and it is detected that the body or lower limbs of the person face the work machine 1, the state determination unit 54 determines that the person is in the state of recognizing the work machine 1. For example, in a case where image processing is performed on the image data and the glasses or mask worn by the person is recognized, the state determination unit 54 determines that the person is in the state of recognizing the work machine 1. For example, in a case where image processing is performed on the image data and the front body of the clothing or the toe portions of the shoes of the person are recognized, the state determination unit 54 determines that the person is the state of recognizing the work machine 1. The state determination unit 54 may determine whether the work machine 1 is recognized by combining a plurality of these conditions. In a case where there is a plurality of people in the periphery of the excavator 1, the state determination unit 54 determines whether all of the people recognize the work machine 1. The state of the person includes the state of the body, and the state of the body includes the direction of the person. The direction of the person may be the direction of the front portion of the body, or the direction of a part thereof.

The state determination unit 54 may once determine that the person recognizes the work machine 1, and then determine that the person continuously recognizes the work machine 1. In addition, after once determining that the person recognizes the work machine 1, the state determination unit 54 may determine that the person continuously recognizes the work machine 1 before a predetermined period elapses, and may end the determination that the person continuously recognizes the work machine 1 after the predetermined period elapses. In this case, in a case where it is determined that the person recognizes the work machine 1 before the predetermined period elapses, the predetermined period may be extended. Note that the person who is determined to recognize the work machine 1 before the predetermined period elapses may be a different person.

In addition, after once determining that the person recognizes the work machine 1, the state determination unit 54 may determine that the person continuously recognizes the work machine 1, for example, in a case where a vehicle body position is changed or a turning angle is changed by operation of the vehicle body of the work machine 1, or a case where the person moves or a face portion or a body direction of the person changes. In addition, in a case where it is determined that the person continuously recognizes the work machine 1, the state determination unit 54 may end the determination that the person continuously recognizes the work machine 1, for example, in a case where a vehicle body position is changed or a turning angle is changed by operation of the vehicle body of the work machine 1, or a case where the person moves or a face portion or a body direction of the person changes. For example, it is possible to determine that the vehicle body position is changed and the turning angle is changed on the basis of operation information of the left working lever 11, the right working lever 12, the left traveling lever 13, and the right traveling lever 14.

The display control unit 55 causes the display unit 21 to display the peripheral image data indicating the situation of the periphery of the excavator 1. Display data includes the peripheral image data. The peripheral image data includes the bird's eye image PDa and the single camera image PDb. In the embodiment, the display control unit 55 causes the display unit 21 to display at least the bird's eye image PDa of the periphery of the excavator 1.

The alarm control unit 56 controls an alarm. More specifically, the alarm control unit 56 outputs any of an operation command for causing an output of an alarm, a stop command for stopping the output of the alarm, and a suppression command for suppressing the output of the alarm.

The alarm is output when the operation command is output. For example, in a case where buzzers of the inner alarm portion 24 and the outer alarm portions 60 are alarms, the buzzers of the inner alarm portion 24 and the outer alarm portions 60 are output when the operation command is output. For example, in a case where the alarm is a display of a message or a symbol on the display unit 21, the message or the symbol is output to the display unit 21 under the control of the display control unit 55 when the operation command is output.

The output of the alarm is stopped when the stop command is output. For example, in a case where the alarm is the inner alarm portion 24, the buzzer of the inner alarm portion 24 is stopped when the stop command is output. For example, in a case where the alarm is the buzzers of the outer alarm portions 60, the buzzers of the outer alarm portions 60 are stopped when the stop command is output. For example, in a case where the alarm is a display of a message or a symbol on the display unit 21, the message or the symbol is not output to the display unit 21 under the control of the display control unit 55 when the stop command is output.

The output of the alarm is suppressed when the suppression command is output. For example, in a case where the alarm is the inner alarm portion 24, the buzzer is not output from the inner alarm portion 24 or a volume is reduced when the suppression command is output. For example, in a case where the alarm is the outer alarm portions 60, the buzzers are not output from the outer alarm portions 60 or a volume is reduced when the suppression command is output. For example, in a case where the alarm is a display of a message or a symbol on the display unit 21, the message or the symbol is not output to the display unit 21 or a size of the display is made smaller when the suppression command is output.

The alarm control unit 56 controls the output of the alarm by at least one of the inner alarm portion 24 or the outer alarm portions 60 on the basis of at least one of the determination result of the person determination unit 53 or the determination result of the state determination unit 54. More specifically, according to the presence or absence of the person in the periphery of the work machine 1, the alarm control unit 56 controls the output of the alarm and the stop of the output by at least one of the inner alarm portion 24 or the outer alarm portions 60. Furthermore, in a case where the person faces the work machine 1 according to the determination result of the state determination unit 54, the alarm control unit 56 suppresses the output of the alarm by at least one of the inner alarm portion 24 or the outer alarm portions 60.

For example, in a case of a “first case” in which the person determination unit 53 determines that the person is present inside the second alarm range Bb, the alarm control unit 56 outputs the alarms from the inner alarm portion 24 and the outer alarm portions 60.

For example, in a case of a “second case” in which the person determination unit 53 determines that the person is present inside the first alarm range Ba and outside the second alarm range Bb, the alarm control unit 56 outputs the alarms from the inner alarm portion 24 and the outer alarm portions 60. Furthermore, the output of the alarms from the outer alarm portions 60 is controlled with respect to each detection range in the following manner.

For example, in a case of a “third case” that is the case of the “second case” and is a case where the state determination unit 54 determines, with respect to a detection range, that states of all people in the detection range are the state of suppressing the alarm, the alarm control unit 56 suppresses the output of the alarm from the outer alarm portion 60 that outputs the alarm in a direction in which the people facing the work machine 1 are detected. More specifically, in a case where it is determined, with respect to the detection range, that the person is present inside the first alarm range Ba and outside the second alarm range Bb, and that all people in the detection range are in the state of recognizing the work machine 1 on the basis of the determination result of the state determination unit 54, the alarm control unit 56 suppresses the output of the alarm from the outer alarm portion 60 arranged in a manner of facing the detection range.

For example, in a case of a “fourth case” that is the case of the “second case” and is a case where the state determination unit 54 determines, with respect to the detection range, that states of one or more people in the detection range are not the state of suppressing the alarm, the alarm control unit 56 outputs the alarm from the outer alarm portion 60 that outputs the alarm in a direction in which the people facing the work machine 1 is detected. More specifically, in a case where it is determined, with respect to the detection range, that the person is present inside the first alarm range Ba and outside the second alarm range Bb, and that one or more people in the detection range are not in the state of recognizing the work machine 1 on the basis of the determination result of the state determination unit 54, the alarm control unit 56 normally outputs the alarm from the outer alarm portion 60 arranged in a manner of facing the detection range.

For example, in a case of a “fifth case” that is the case of the “second case” and is a case where the person determination unit 53 determines, with respect to the detection range, that no person is present in the detection range, the alarm control unit 56 stops the output of the alarm from the outer alarm portion 60 arranged in such a manner as to face the detection range.

For example, in a case of a “case 6” in which the person determination unit 53 determines that no person is present in the alarm range B, the alarm control unit 56 stops the output of the alarm from the inner alarm portion 24.

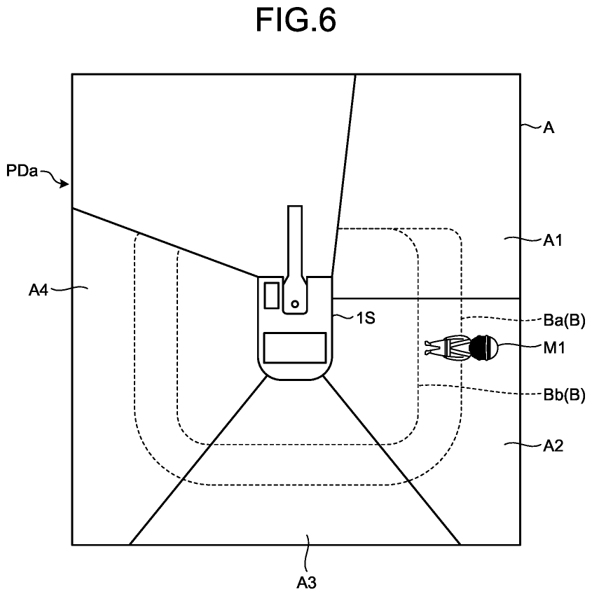

FIG. 6 is a view illustrating an example of a display example of the bird's eye image PDa of the display unit 21 according to the embodiment. In a state in which the bird's eye image PDa illustrated in FIG. 6 is displayed on the display unit 21, the state determination unit 54 determines that a person M1 is present inside the first alarm range Ba and outside the second alarm range Bb, and in the detection range A2, and that the person M1 is not in the state of recognizing the work machine 1. This is the case of the “fourth case”. In this case, the alarm control unit 56 outputs the alarm from all the outer alarm portions 60 or the outer alarm portion 63 corresponding to the detection range A2 on the basis of the determination result of the state determination unit 54.

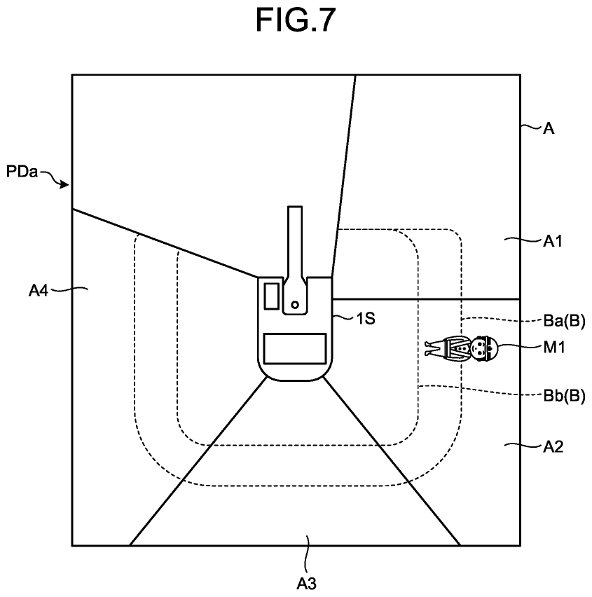

FIG. 7 is a view illustrating another example of the display example of the bird's eye image PDa of the display unit 21 according to the embodiment. In a state in which the bird's eye image PDa illustrated in FIG. 7 is displayed on the display unit 21, the state determination unit 54 determines that the person M1 is present inside the first alarm range Ba and outside the second alarm range Bb, and in the detection range A2, and that the person M1 is in the state of recognizing the work machine 1. This is the case of the “third case”. In this case, the alarm control unit 56 suppresses the output of the alarm from the outer alarm portion 63 among the outer alarm portions 60 on the basis of the determination result of the state determination unit 54.

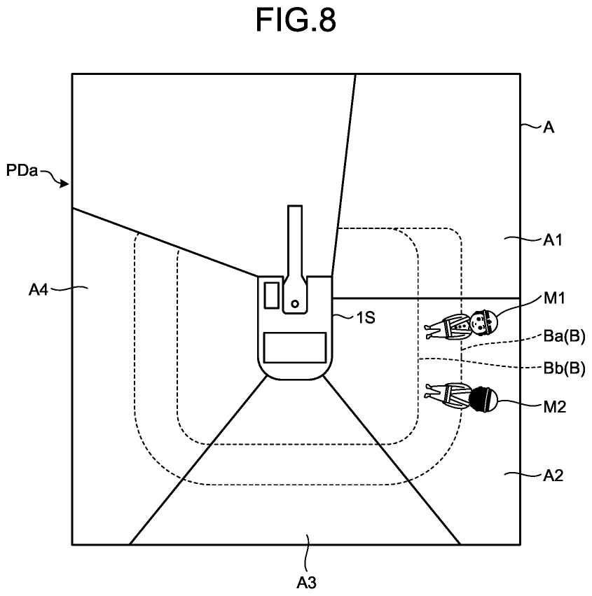

FIG. 8 is a view illustrating another example of the display example of the bird's eye image PDa of the display unit 21 according to the embodiment. In a state in which the bird's eye image PDa illustrated in FIG. 8 is displayed on the display unit 21, the state determination unit 54 determines that the person M1 is present inside the first alarm range Ba and outside the second alarm range Bb, and in the detection range A2, and that the person M1 is in the state of recognizing the work machine 1. It is determined that a person M2 is present inside the first alarm range Ba and outside the second alarm range Bb, and in the detection range A2, and that the person M2 is not in the state of recognizing the work machine 1. In this example, the person M1 who recognizes the work machine 1 and the person M2 who does not recognize the work machine 1 are present in the detection range A2. This is the case of the “fourth case”. In this case, the alarm control unit 56 outputs the alarm from all the outer alarm portions 60 or the outer alarm portion 63 corresponding to the detection range A2 on the basis of the determination result of the state determination unit 54.

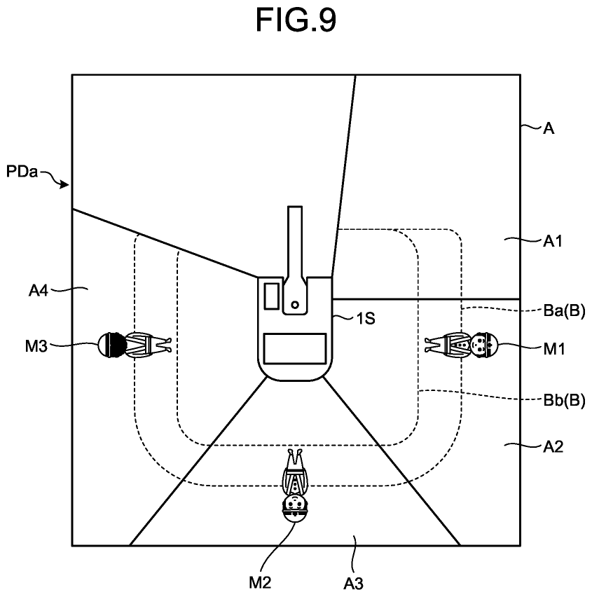

FIG. 9 is a view illustrating another example of the display example of the bird's eye image PDa of the display unit 21 according to the embodiment. In a state in which the bird's eye image PDa illustrated in FIG. 9 is displayed on the display unit 21, the state determination unit 54 determines that the person M1 is present inside the first alarm range Ba and outside the second alarm range Bb, and in the detection range A2, and that the person M1 is in the state of recognizing the work machine 1. The state determination unit 54 determines that the person M2 is present inside the first alarm range Ba and outside the second alarm range Bb, and in the detection range A3, and that the person M2 is in the state of recognizing the work machine 1. The state determination unit 54 determines that a person M3 is present inside the first alarm range Ba and outside the second alarm range Bb, and in the detection range A4, and that the person M3 is not in the state of recognizing the work machine 1. In this example, the person M1 who recognizes the work machine 1 is present in the detection range A2, the person M2 who recognizes the work machine 1 is present in the detection range A3, and the person M3 who does not recognize the work machine 1 is present in the detection range A4. This is the case of the “third case” and the “fourth case”. In this case, the alarm control unit 56 suppresses the output of the alarms from the outer alarm portion 61 and the outer alarm portion 62 among the outer alarm portions 60, and outputs the alarm from the outer alarm portion 64 on the basis of the determination results of the state determination unit 54.

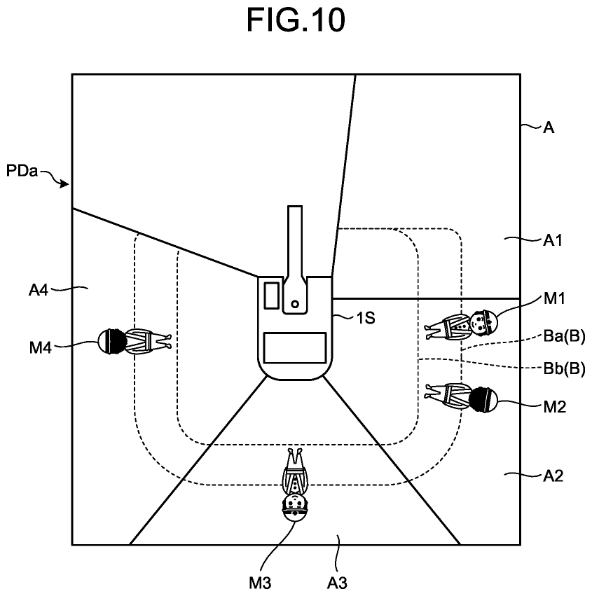

FIG. 10 is a view illustrating another example of the display example of the bird's eye image PDa of the display unit 21 according to the embodiment. In a state in which the bird's eye image PDa illustrated in FIG. 10 is displayed on the display unit 21, the state determination unit 54 determines that the person M1 is present inside the first alarm range Ba and outside the second alarm range Bb, and in the detection range A2, and that the person M1 is in the state of recognizing the work machine 1. The state determination unit 54 determines that the person M2 is present inside the first alarm range Ba and outside the second alarm range Bb, and in the detection range A2, and that the person M2 is not in the state of recognizing the work machine 1. The state determination unit 54 determines that the person M3 is present inside the first alarm range Ba and outside the second alarm range Bb, and in the detection range A3, and that the person M3 is in the state of recognizing the work machine 1. The state determination unit 54 determines that a person M4 is present inside the first alarm range Ba and outside the second alarm range Bb, and in the detection range A4, and that the person M4 is not in the state of recognizing the work machine 1. In this example, the person M1 who recognizes the work machine 1 and the person M2 who does not recognize the work machine 1 are present in the detection range A2, the person M2 who recognizes the work machine 1 is present in the detection range A3, and the person M3 who does not recognize the work machine 1 is present in the detection range A4. This is the case of the “third case” and the “fourth case”. In this case, the alarm control unit 56 suppresses the output of the alarm from the outer alarm portion 61 among the outer alarm portions 60, and outputs the alarms from the outer alarm portion 62 and the outer alarm portion 64 on the basis of the determination results of the state determination unit 54.

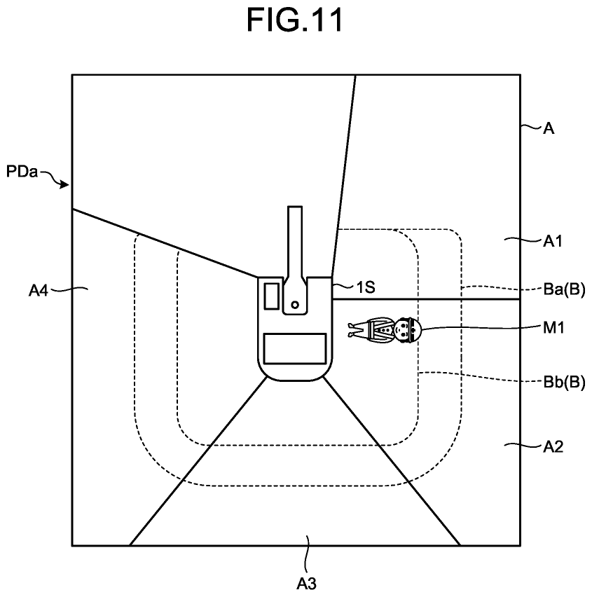

FIG. 11 is a view illustrating another example of the display example of the bird's eye image PDa of the display unit 21 according to the embodiment. In a state in which the bird's eye image PDa illustrated in FIG. 11 is displayed on the display unit 21, the state determination unit 54 determines that the person M1 is present inside the second alarm range Bb and in the detection range A2, and that the person M1 is in the state of recognizing the work machine 1. This is the case of the “first case”. In this case, the person M1 is present inside the second alarm range Bb and is close to the work machine 1 although recognizing the work machine 1 in this example. Thus, the alarm is output without suppression. In this case, the alarms are output from all the outer alarm portions 60 including the outer alarm portion 62 by the alarm control unit 56.

FIG. 12 is a view illustrating an example of the display example of the single camera image PDb of the display unit 21 according to the embodiment. In a state in which the single camera image PDb of the right rear camera 32 which image is illustrated in FIG. 12 is displayed on the display unit 21, the state determination unit 54 determines that the person M1 is present inside the first alarm range Ba and outside the second alarm range Bb, and in the detection range A2, and that the person M1 is in the state of recognizing the work machine 1. This is the case of the “third case”. A position of the person M1 can be determined by, for example, a height of the person M1 in a height direction of the image or a display position of the person M1 in the image. The position of the person M1 may be determined, for example, on the basis of an image photographed by a stereo camera. It is assumed that no person is displayed in the other single camera images PDb. In this case, the alarm control unit 56 suppresses the output of the alarm from the outer alarm portion 63 among the outer alarm portions 60 on the basis of the determination result of the state determination unit 54.

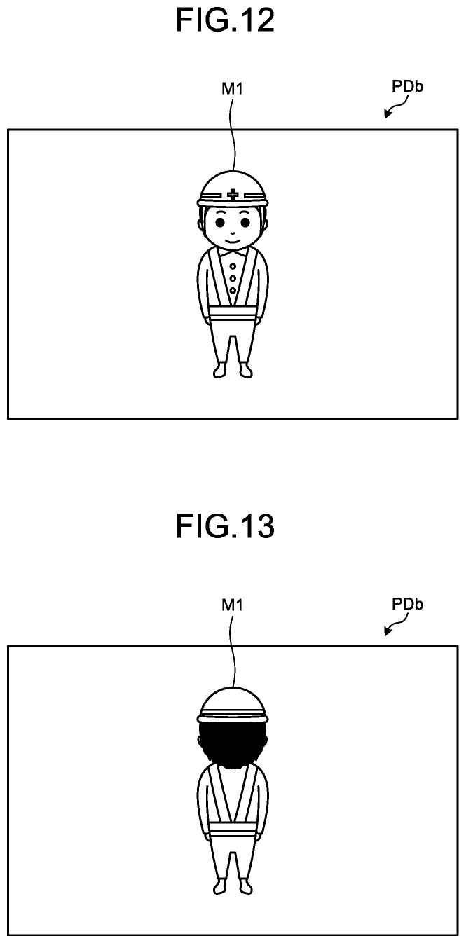

FIG. 13 is a view illustrating another example of the display example of the single camera image of the display unit 21 according to the embodiment. In a state in which the single camera image PDb of the right rear camera 32 which image is illustrated in FIG. 13 is displayed on the display unit 21, the state determination unit 54 determines that the person M1 is present inside the first alarm range Ba and outside the second alarm range Bb, and in the detection range A2, and that the person M1 is not in the state of recognizing the work machine 1. This is the case of the “fourth case”. It is assumed that no person is displayed in the other single camera images PDb. In this case, the alarm control unit 56 outputs the alarm from all the outer alarm portions 60 or the outer alarm portion 63 corresponding to the detection range A2 on the basis of the determination result of the state determination unit 54.

[Periphery Monitoring Method]

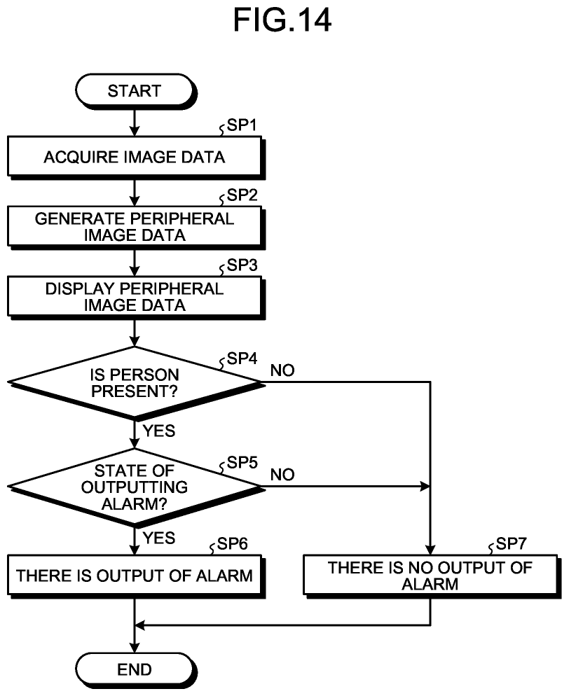

FIG. 14 is a flowchart illustrating a periphery monitoring method according to the embodiment. When the excavator 1 is keyed on, the periphery monitoring device 100 is activated. Immediately after the periphery monitoring device 100 is activated, the periphery monitoring device 100 outputs an alarm due to presence of a person in the periphery of the excavator 1.

The cameras 30 image the periphery of the excavator 1. The image data acquisition unit 51 acquires image data from the cameras 30 (Step SP1).

The display data generation unit 52 generates the peripheral image data. The display data generation unit 52 generates the bird's eye image PDa from the image data photographed by the plurality of cameras 30 (Step SP2).

The display control unit 55 causes the display unit 21 to display the bird's eye image PDa (Step SP3).

Note that the single camera image PDb may be generated in Step SP2, and the single camera image PDb may be displayed in Step SP3. Alternatively, a bird's-eye view camera image PDa and the single camera image PDb may be generated in Step SP2, and the bird's-eye view camera image PDa and the single camera image PDb may be displayed in Step SP3.

The person determination unit 53 determines whether a person is present in the alarm range B (Step SP4). More specifically, the person determination unit 53 collates a feature amount extracted from the image data with the feature amount stored in the feature amount storage unit 57, and determines whether a person is present in the alarm range B. Furthermore, the person determination unit 53 determines in which range a person is present among the outside of the first alarm range Ba, the inside of the first alarm range Ba and the outside of the second alarm range Bb, and the inside of the second alarm range Bb. Furthermore, the person determination unit 53 determines in which range of the detection range Al, the detection range A2, the detection range A3, or the detection range A4 a person is present.

In a case where the person determination unit 53 determines that a person is present in the alarm range B (Yes in Step SP4), processing of Step S5 to Step SP7 is executed for each detection range. In a case where the person determination unit 53 determines that no person is present in the alarm range B (No in Step SP4), the processing proceeds to Step SP7.

In a case where the person determination unit 53 determines that the person is present in the alarm range B (Yes in Step SP4), the state determination unit 54 determines whether a state is a state of outputting an alarm (Step SP5). More specifically, for example, on the basis of a direction of a face portion or a body of the person, the state determination unit 54 determines whether the state of the person is a state in which the person recognizes the work machine 1. In a case where there is a plurality of people in the alarm range B, the state determination unit 54 determines whether all of the people recognize the work machine 1. In a case where the state determination unit 54 determines that the state is the state of outputting the alarm (Yes in Step SP5), the processing proceeds to Step SP6. In a case where the state determination unit 54 determines that the state is not the state of outputting the alarm (No in Step SP5), the processing proceeds to Step SP7.

In a case where the state determination unit 54 determines that the state is the state of outputting the alarm (Yes in Step SP5), the alarm control unit 56 outputs the operation command for causing the output of the alarm

(Step SP6). The alarm control unit 56 outputs the alarm in a case where there is a person who does not recognize the work machine 1 in a work range B. For example, in a case of a “first case” in which the person determination unit 53 determines that the person is present inside the second alarm range Bb, the alarm control unit 56 outputs the alarms from the inner alarm portion 24 and the outer alarm portions 60. Alternatively, in a case of the “fourth case” that is the case of the “second case” and is a case where the state determination unit 54 determines, with respect to a detection range, that states of one or more people in the detection range are not the state of suppressing the alarm, the alarm control unit 56 outputs the alarm from the outer alarm portion 60 that is arranged in such a manner as to face the detection region.

In a case where the state determination unit 54 determines that the state is not the state of outputting the alarm (No in Step SP5), the alarm control unit 56 outputs the stop command for stopping the output of the alarm (Step SP7). Here, not being the state of outputting the alarm includes not outputting the alarm, and suppressing the output. In addition, the stop command includes the suppression command for suppressing the output of the alarm. In a case where no person is present in the work range B or in a case where only a person who recognizes the work machine 1 is present in the work range B (case where all people recognize the work machine 1), the alarm control unit 56 suppresses the output of the alarm. For example, in a case where the state determination unit 54 determines that the state is the state of suppressing the alarm, the alarm control unit 56 outputs the suppression command for suppressing the output of the alarm. More specifically, in a case of the “third case” that is the case of the “second case” and is a case where the state determination unit 54 determines, with respect to the detection range, that states of all people in the detection range are the state of suppressing the alarm, the alarm control unit 56 suppresses the output of the alarm from the outer alarm portion 60 arranged in such a manner as to face the detection range, and does not output the alarm from the outer alarm portion 60 arranged in such a manner as to face the detection range.

In addition, in a case where a person is present inside the second alarm range Bb, the operation of the vehicle body of the work machine 1 may be limited.

By repeatedly executing the above processing, the periphery monitoring device 100 performs periphery monitoring of the excavator 1. As a result, for example, in a case of the “fifth case” that is the case of the “second case” and is a case where the person determination unit 53 determines, with respect to the detection range, that no person is present in the detection range, the alarm control unit 56 stops the output of the alarm from the outer alarm portion 60 arranged in such a manner as to face the detection range. In a case of a “case 6” in which the person determination unit 53 determines that no person is present in the alarm range B, the alarm control unit 56 stops the output of the alarm from the inner alarm portion 24.

Note that the flowchart illustrated in FIG. 14 is an example, and not all steps need to be executed in another embodiment. For example, the periphery monitoring device 100 may not execute Steps SP2 and Step SP3.

[Computer System]

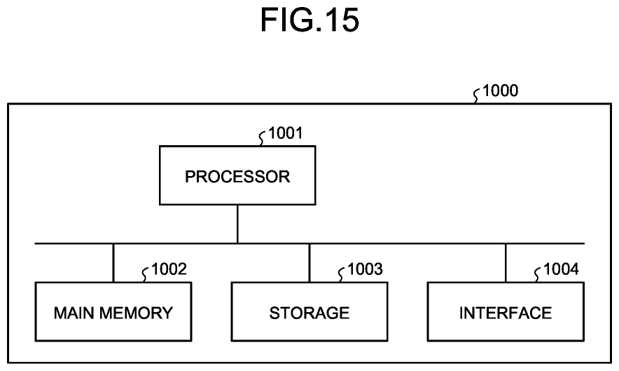

FIG. 15 is a block diagram illustrating a computer system 1000 according to the embodiment. The above-described control unit 23 includes the computer system 1000. The computer system 1000 includes a processor 1001 such as a central processing unit (CPU), a main memory 1002 including a non-volatile memory such as a read only memory (ROM) and a volatile memory such as a random access memory (RAM), a storage 1003, and an interface 1004 including an input/output circuit. A function of the above-described control unit 23 is stored as a computer program in the storage 1003. The processor 1001 reads a computer program from the storage 1003, develops the computer program into the main memory 1002, and executes the above-described processing according to the computer program. Note that the computer program may be distributed to the computer system 1000 through a network.

According to the above-described embodiment, the computer program or the computer system 1000 can cause execution of detecting a person in the periphery of the work machine 1, outputting an alarm, determining a state of the detected person, controlling the output of the alarm according to presence or absence of the person in the periphery of the work machine 1, and suppressing the output of the alarm according to a determination result of the state of the person.

As described above, for example, in a case where a face portion of a person faces the work machine 1 and it is determined that the work machine 1 is recognized, the output of the alarm is suppressed. The alarm may be the inner alarm portion 24 or the outer alarm portions 60.

Note that both of the inner alarm portion 24 and the outer alarm portions 60 may be included, or either one may be included. In a case where both of the inner alarm portion 24 and the outer alarm portions 60 are included and, for example, in a case where the face portion of the person faces the work machine 1 and it is determined that the work machine 1 is recognized, the output of the both alarms may be suppressed, or the output of either one of the alarms may be suppressed.

[Effect]

As described above, in a case where a person is present in the periphery of the work machine 1 and the person recognizes the work machine 1, an output of an alarm is suppressed. As described above, according to the embodiment, in a case where the person is present in the periphery of the work machine 1, the output of the alarm can be controlled according to a state of the person. According to the embodiment, it is possible to suppress the output of the alarm with low necessity.

In the embodiment, the outer alarm portions 60 that output alarms toward the outside of the work machine 1, and the inner alarm portion 24 that outputs an alarm toward the inside of the cab 6 of the work machine 1 are included. In the embodiment, in a case where the person is present in the periphery of the work machine 1, the output of the alarms by the outer alarm portions 60 can be suppressed according to the state of the person. According to the embodiment, in a case where the person is present in the periphery of the work machine 1, the alarm can be output to a driver regardless of the state of the person.

In the embodiment, the plurality of outer alarm portions 60 that outputs alarms in different directions outside the work machine 1 is included. In the embodiment, it is possible to suppress the output of the alarm by the outer alarm portion 60 that outputs the alarm in a direction in which a person facing the work machine 1 is detected among the plurality of outer alarm portions 60. According to the embodiment, the alarm can be output from the outer alarm portion 60 that outputs the alarm in a direction in which a person who does not face the work machine 1 is present.

In the embodiment, a state of a person is determined on the basis of images photographed by the cameras 30 that photograph the periphery of the work machine 1. According to the embodiment, it is not necessary to install an additional sensor, camera, or the like to determine the state of the person.

In the embodiment, it is determined that a person continuously recognizes the work machine 1, for example, even in a case where a direction of a face portion or a body of the person changes after it is once determined that the person recognizes the work machine 1. According to the present embodiment, it is possible to more appropriately suppress the output of the alarm in a case where a relative position of the person and the work machine 1 changes. More specifically, it is possible to prevent the output or suppression of the alarm from changing every time a relative position of the person and the work machine 1 changes, for example, in a case where the person moves or a vehicle body position of the work machine 1 changes after it is determined that the person recognizes the work machine 1, and the alarm from becoming annoying. In addition, according to the present embodiment, in a case where the work machine 1 shakes, or in a case where the work machine 1 performs predetermined operation such as excavation and loading and a boundary between a state in which it is determined that a person recognizes the work machine 1 and a state in which it is not determined that the person recognizes the work machine 1 varies, it is possible to prevent the alarm from being repeatedly output and suppressed and from becoming annoying.

In the embodiment, in a case where it is determined that the person continuously recognizes the work machine 1, and in a case where the vehicle body of the work machine 1 operates and the vehicle position changes or the turning angle changes, the determination that the person continuously recognizes the work machine 1 is ended. According to the present embodiment, it is possible to appropriately output the alarm in a case where a relative positional relationship between the person and the work machine 1 changes.

### Other Embodiments

In the above-described embodiment, it is assumed that the detection units are the cameras 30 that photograph the periphery of the work machine 1. A detection unit is not limited to a camera 30. The detection unit may be a stereo camera provided in an excavator 1, or may be a radar device or a laser device.

In the above-described embodiment, it is assumed that the periphery monitoring monitor 20 includes the display unit 21, the operation unit 22, the control unit 23, and the inner alarm portion 24. A display unit 21, an operation unit 22, a control unit 23, and an inner alarm portion 24 may be partially separated, or may be separated from each other. For example, the display unit 21 may be a display unit provided outside a work machine, such as a tablet personal computer. Note that an operation unit 22 provided outside a periphery monitoring monitor 20 may be arranged at another place in a cab 6 or may be provided outside the cab 6. Alternatively, in addition to an operation unit 22 included in a periphery monitoring monitor 20, the above operation unit 22 may be provided.

Although it is assumed that the plurality of outer alarm portions 60 is installed in the above embodiment, this is not a limitation. There may be one outer alarm portion 60. The external alarm unit 600 may include one outer alarm portion 60.

In the above-described embodiment, it is assumed that the inner alarm portion 24 and the outer alarm portions 60 output buzzers. An inner alarm portion 24 and an outer alarm portion 60 may be audio output devices. In this case, an alarm may be sound output from the audio output device. Furthermore, an inner alarm portion 24 and an outer alarm portion 60 may be warning lights.

In the above embodiment, it has been described that the peripheral display data includes the bird's eye image PDa and the single camera image PDb. However, this is not a limitation. Peripheral display data may be either a bird's eye image PDa or a single camera image PDb. Furthermore, it has been described that the peripheral display data is displayed in the above embodiment. However, peripheral display data may not be displayed.

In addition, the periphery monitoring device 100 according to the above-described embodiment has been described on the assumption that one periphery monitoring device 100 is installed in the work machine 1. However, in another embodiment, a configuration of a part of a periphery monitoring device 100 may be arranged in another control device, and another embodiment may be realized by a periphery monitoring system including two or more periphery monitoring devices 100. Note that the one periphery monitoring device 100 described in the above-described embodiment is also an example of the periphery monitoring system.

In addition, although the periphery monitoring device 100 according to the above-described embodiment has been described to be installed in the work machine 1, a part or whole configuration of a periphery monitoring device 100 may be installed outside a work machine 1 in another embodiment. For example, in another embodiment, the periphery monitoring device 100 may control the work machine 1 related to remote operation.

In the above-described embodiment, the excavator 1 may be a mining excavator used in a mine or the like, or may be an excavator used in a construction site. In addition, application to a periphery monitoring system for a dump truck, a wheel loader, or another work machine is possible.

### REFERENCE SIGNS LIST

1 EXCAVATOR (WORK MACHINE)

1S SYMBOL IMAGE

2 LOWER TRAVELING BODY

3 UPPER TURNING BODY

4 WORKING EQUIPMENT

4A BOOM

4B ARM

4C BUCKET

5 HYDRAULIC CYLINDER

5A BOOM CYLINDER

5B ARM CYLINDER

5C BUCKET CYLINDER

6 CAB

9 DRIVER SEAT

10 OPERATION UNIT

11 LEFT WORKING LEVER

12 RIGHT WORKING LEVER

13 LEFT TRAVELING LEVER

14 RIGHT TRAVELING LEVER

15 LEFT FOOT PEDAL

16 RIGHT FOOT PEDAL

20 PERIPHERY MONITORING MONITOR

21 DISPLAY UNIT

22 OPERATION UNIT

23 CONTROL UNIT

24 INNER ALARM PORTION (ALARM PORTION)

30 CAMERA (DETECTION UNIT)

31 REAR CAMERA

32 RIGHT REAR CAMERA

33 RIGHT FRONT CAMERA

34 LEFT REAR CAMERA

41 ARITHMETIC PROCESSING UNIT

42 STORAGE UNIT

43 INPUT/OUTPUT INTERFACE

51 IMAGE DATA ACQUISITION UNIT

52 DISPLAY DATA GENERATION UNIT

53 PERSON DETERMINATION UNIT

54 STATE DETERMINATION UNIT

55 DISPLAY CONTROL UNIT

56 ALARM CONTROL UNIT

57 FEATURE AMOUNT STORAGE UNIT

58 ALARM RANGE STORAGE UNIT

60 OUTER ALARM PORTION (ALARM PORTION)

61 OUTER ALARM PORTION

62 OUTER ALARM PORTION

63 OUTER ALARM PORTION

64 OUTER ALARM PORTION

100 PERIPHERY MONITORING DEVICE

300 CAMERA SYSTEM

600 OUTER ALARM UNIT

1000 COMPUTER SYSTEM

1001 PROCESSOR

1002 MAIN MEMORY

1003 STORAGE

1004 INTERFACE

A DETECTION RANGE

A1 DETECTION RANGE

A2 DETECTION RANGE

A3 DETECTION RANGE

A4 DETECTION RANGE AX BOOM ROTATION AXIS

B ALARM RANGE

Ba FIRST ALARM RANGE

Bb SECOND ALARM RANGE

BX ARM ROTATION AXIS

CX BUCKET ROTATION AXIS

PDa BIRD'S EYE IMAGE

PDb SINGLE CAMERA IMAGE

RX TURNING AXIS

1. A work machine periphery monitoring system comprising:
a detection unit that detects a person in a periphery of a work machine;
an alarm portion that outputs an alarm;
a state determination unit that determines a state of a body of the person detected by the detection unit; and
an alarm control unit that controls the output of the alarm by the alarm portion on a basis of a determination result of the state determination unit.

2. The work machine periphery monitoring system according to claim 1, wherein
the alarm control unit outputs the alarm by the alarm portion according to presence or absence of the person in the periphery of the work machine, and suppresses the output of the alarm by the alarm portion according to a determination result of the state determination unit.

3. The work machine periphery monitoring system according to claim 1, wherein
the alarm portion includes a plurality of outer alarm portions that output alarms in different directions in the periphery of the work machine, and
the alarm control unit suppresses the output of the alarm by the outer alarm portion that outputs the alarm in a direction in which a person facing the work machine is detected among the plurality of outer alarm portions according to the determination result of the state determination unit.

4. The work machine periphery monitoring system according to claim 1, wherein
the detection unit is a camera that photographs the periphery of the work machine, and
the state determination unit determines the state of the body of the person on a basis of an image photographed by the camera.

5. The work machine periphery monitoring system according to claim 1, wherein
a plurality of the detection units are arranged in a periphery of the work machine, and
a plurality of the alarm portions are arranged in a periphery of the detection units.

6. The work machine periphery monitoring system according to claim 1, wherein
the state determination unit determines that the person continuously faces the work machine after determining that the person faces the work machine.

7. The work machine periphery monitoring system according to claim 6, wherein
in a case where it is determined that the person continuously faces the work machine, when a relative positional relationship between the person and the work machine changes, the state determination unit ends the determination that the person continuously faces the work machine.

8. A work machine comprising:
the work machine periphery monitoring system according to claim 1.

9. A work machine periphery monitoring method comprising:
detecting a person in a periphery of a work machine;
outputting an alarm;
determining a state of a body of the detected person; and
controlling the output of the alarm on a basis of a determination result of the state of the body.
